(19) United States
(12) Patent Application Publication
(10) Pub. No.: US 2019/0280615 A1
(43) Pub. Date: Sep. 12, 2019

(54) MODULATION METHOD AND APPARATUS BASED ON THREE-PHASE NEUTRAL POINT CLAMPED INVERTER

(71) Applicant: SMA Solar Technology AG, Niestetal (DE)

(72) Inventors: Siew Chun Ng, Suzhou (CN); Shijun Li, Suzhou (CN); Chao Zhang, Suzhou (CN); Zhaomi Wu, Suzhou (CN)

(21) Appl. No.: 16/423,527

(22) Filed: May 28, 2019

Related U.S. Application Data
(63) Continuation of application No. PCT/EP2017/082881, filed on Dec. 14, 2017.

(30) Foreign Application Priority Data
Dec. 31, 2016 (CN) 201611256633.4

(51) Int. Cl. H02M 7/487; H02M 7/5387

(52) U.S. Cl. CPC H02M 7/487; H02M 7/53871

(57) ABSTRACT

Embodiments of the present disclosure disclose a modulation method and apparatus based on a three-phase neutral point clamped inverter. The method includes outputting a control signal for controlling all the switch elements of one of the three bridge arms to be in a non-conducting state, controlling states of the switch elements of the other two bridge arms to make the three-phase neutral point clamped inverter output a single-phase signal, wherein the two bridge arms are referred to as a first single-phase bridge arm and a second single-phase bridge arm, when controlling both switch elements connected to the first input end and switch elements connected to the second input end in the first single-phase bridge arm and the second single-phase bridge arm to be in the non-conducting state, controlling two of the other switch elements in the first single-phase bridge arm and the second single-phase bridge arm to be in a conducting state to provide a freewheeling loop for an inductive current of the inverter. The scheme provided by the embodiments of the present disclosure has relatively small current ripples, smaller switch tube loss and smaller inductor loss, improving efficiency of the inverter.

### CROSS REFERENCE TO RELATED APPLICATIONS

This application is a continuation of International Patent Application number PCT/EP2017/082881, filed on Dec. 14, 2017, which claims priority to Chinese Patent Application number 201611256633.4, filed on Dec. 31, 2016, and is hereby incorporated by reference in its entirety.

### FIELD

The present disclosure relates to an inverter technology, and in particular, to a modulation method and apparatus based on a three-phase neutral point clamped (NPC) inverter.

### BACKGROUND

As the market for energy storage inverters is more and more mature, the market's demand for grid-connected inverters to have a single-phase switching power supply (SPS) function is also getting greater. In order to ensure competitiveness of their market, inverter manufacturers should meet the market demand without increasing the hardware cost. In addition, the efficiency of the inverters in a single-phase mode of operation is also a major factor in ensuring competitiveness of products in the market.

FIG. 1(a) and FIG. 1(b) are schematic diagrams of a conventional three-phase and three-level NPC topology. As shown in FIG. 1(a) and FIG. 1(b), the conventional three-phase and three-level NPC topology includes two Bus capacitors connected in series between input ends, three bridge arms consisting of 12 switch tubes, three output inductors and three output capacitors, wherein neutral points of the three output capacitors are connected to neutral points of the Bus capacitors.

As shown in FIG. 1(a), since element link relations of three phases of the inverter are the same, only the link relation of one phase is described as an example. Taking A phase as an example, Q1a and Q4a connected in series are connected in parallel at both ends of the two bus capacitors, one end of Q2a is connected to a connection point of Q1a and Q4a, the other end of Q2a is connected to one end of Q3a, the other end of Q3a is connected to a neutral point M of the bus capacitor, one end of the inductor L is connected to the connection point of Q1a and Q4a, the other end of the inductor L is connected to an output end, one end of the capacitor C is connected to the output end and the other end of the capacitor C is connected to the neutral point M of the bus capacitor.

As shown in FIG. 1(b), since element link relations of three phases of the inverter are the same, only the link relation of one phase is described as an example. Taking A phase as an example, Q1a, Q2a, Q3a and Q4a connected in series are connected in parallel at both ends of the two bus capacitors, two diodes connected in series are connected in parallel at both ends of Q2a and Q3a, a connection point of the two diodes is connected to the neutral point M of the bus capacitor, one end of the inductor L is connected to the connection point of Q2a and Q3a, the other end of the inductor L is connected to the output end, one end of the capacitor C is connected to the output end and the other end of the capacitor C is connected to the neutral point M of the bus capacitor.

### SUMMARY

In order to solve the technical problems described above, the present disclosure provides a modulation method and apparatus based on a three-phase NPC inverter to implement the integrated function of a single-phase inverter and three-phase inverter.

In order to achieve the object of the present disclosure, one embodiment of the present disclosure provides a modulation method based on a three-phase neutral point clamped inverter, wherein the three-phase neutral point clamped inverter includes three bridge arms comprised of switch elements and three inductors, one end of the inductor is connected to an output end of the inverter, each of the bridge arms includes four switch elements and the switch elements of each of the bridge arms are connected in a same way. In each of the bridge arms, a switch element is connected to a first input end of the three-phase neutral point clamped inverter, and a switch element is connected to a second input end of the three-phase neutral point clamped inverter. The method includes in one embodiment: outputting a control signal for controlling all the switch elements of one of the three bridge arms to be in a non-conducting state, and controlling states of the switch elements of the other two bridge arms to make the three-phase neutral point clamped inverter output a single-phase signal. The other two bridge arms are referred to as a first single-phase bridge arm and a second single-phase bridge arm. Such method occurs when controlling both switch elements connected to the first input end and switch elements connected to the second input end in the first single-phase bridge arm and the second single-phase bridge arm to be in the non-conducting state, and controlling two of the other switch elements in the first single-phase bridge arm and the second single-phase bridge arm to be in a conducting state to provide a freewheeling loop for an inductive current of the inverter.

Optionally, or in another embodiment, the first single-phase bridge arm includes a first switch element, a second switch element, a third switch element and a fourth switch element, and the second single-phase bridge arm includes a fifth switch element, a sixth switch element, a seventh switch element and an eighth switch element. One end of the first switch element and one end of the fifth switch element are connected to the first input end, the other end of the first switch element is connected to one end of the second switch element, the other end of the second switch element is connected to one end of the third switch element, the other end of the fifth switch element is connected to one end of the sixth switch element, the other end of the sixth switch element is connected to one end of the seventh switch element, and one end of the fourth switch element and one end of the eighth switch element are connected to the second input end. Further, controlling states of the switch elements of the other two bridge arms to make the three-phase neutral point clamped inverter output a single-phase signal includes: when a current of an inductor connected to the first single-phase bridge arm flows from the inverter to a load, controlling the first switch element and the eighth switch element to be in the conducting state, and controlling the fourth switch element and the fifth switch element to be in the non-conducting state.

Optionally, or in another embodiment, controlling two of the other switch elements in the first single-phase bridge arm and the second single-phase bridge arm to be in the conducting state to provide a freewheeling loop for an inductive current of the inverter includes: when a current of an inductor connected to the first single-phase bridge arm flows from the inverter to the load, controlling the first switch element, the eighth switch element, the fourth switch element and the fifth switch element to be in the non-conducting state, and controlling the third switch element and the sixth switch element to be in the conducting state.

Optionally, or in another embodiment, the first single-phase bridge arm includes a first switch element, a second switch element, a third switch element and a fourth switch element, and the second single-phase bridge arm includes a fifth switch element, a sixth switch element, a seventh switch element and an eighth switch element. One end of the first switch element and one end of the fifth switch element are connected to the first input end, the other end of the first switch element is connected to one end of the second switch element, the other end of the second switch element is connected to one end of the third switch element, the other end of the fifth switch element is connected to one end of the sixth switch element, the other end of the sixth switch element is connected to one end of the seventh switch element, and one end of the fourth switch element and one end of the eighth switch element is connected to the second input end. Further, controlling states of the switch elements of the other two bridge arms to make the three-phase neutral point clamped inverter output a single-phase signal includes: when a current of an inductor connected to the first single-phase bridge arm flows from the load to the inverter, controlling the first switch element and the eighth switch element to be in the non-conducting state, and controlling the fourth switch element and the fifth switch element to be in the conducting state.

Optionally, or in another embodiment, controlling two of the other switch elements in the first single-phase bridge arm and the second single-phase bridge arm to be in the conducting state to provide a freewheeling loop for an inductive current of the inverter includes: when an inductive current on the first single-phase bridge arm flows from the load to the inverter, controlling the first switch element, the eighth switch element, the fourth switch element and the fifth switch element to be in the non-conducting state, and controlling the second switch element and the seventh switch element to be in the conducting state.

An embodiment of the present disclosure further provides a modulation apparatus based on a three-phase neutral point clamped inverter, wherein the three-phase neutral point clamped inverter includes three bridge arms comprised of switch elements and three inductors. One end of the inductor is connected to an output end of the inverter, and each of the bridge arms includes four switch elements and the switch elements of each of the bridge arms are connected in a same way. In each of the bridge arms, a switch element is connected to a first input end of the three-phase neutral point clamped inverter and a switch element is connected to a second input end of the three-phase neutral point clamped inverter. The modulation apparatus includes: a control signal generating module, configured to generate a control signal; and a control signal output module, configured to: output the control signal to the switch elements of the inverter, control all the switch elements of one of the three bridge arms to be in a non-conducting state, and control states of the switch elements of the other two bridge arms to make the three-phase neutral point clamped inverter output a single-phase signal. The two bridge arms are referred to as a first single-phase bridge arm and a second single-phase bridge arm respectively. The control signal output module is further configured to, when controlling both switch elements connected to the first input end and switch elements connected to the second input end in the first single-phase bridge arm and the second single-phase bridge arm to be in the non-conducting state, control two of the other switch elements in the first single-phase bridge arm and the second single-phase bridge arm to be in a conducting state to provide a freewheeling loop for an inductive current of the inverter.

Optionally, or in another embodiment, the first single-phase bridge arm includes a first switch element, a second switch element, a third switch element and a fourth switch element, and the second single-phase bridge arm includes a fifth switch element, a sixth switch element, a seventh switch element and an eighth switch element. One end of the first switch element and one end of the fifth switch element are connected to the first input end, the other end of the first switch element is connected to one end of the second switch element, the other end of the second switch element is connected to one end of the third switch element, the other end of the fifth switch element is connected to one end of the sixth switch element, the other end of the sixth switch element is connected to one end of the seventh switch element, and one end of the fourth switch element and one end of the eighth switch element are connected to the second input end. Further, controlling states of the switch elements of the other two bridge arms to make the three-phase neutral point clamped inverter output a single-phase signal includes: when a current of an inductor connected to the first single-phase bridge arm flows from the inverter to a load, controlling the first switch element and the eighth switch element to be in the conducting state, and controlling the fourth switch element and the fifth switch element to be in the non-conducting state.

Optionally, or in another embodiment, controlling two of the other switch elements in the first single-phase bridge arm and the second single-phase bridge arm to be in the conducting state to provide a freewheeling loop for an inductive current of the inverter includes: when a current of an inductor connected to the first single-phase bridge arm flows from the inverter to the load, controlling the first switch element, the eighth switch element, the fourth switch element and the fifth switch element to be in the non-conducting state, and controlling the third switch element and the sixth switch element to be in the conducting state.

Optionally, or in another embodiment, the first single-phase bridge arm includes a first switch element, a second switch element, a third switch element and a fourth switch element, and the second single-phase bridge arm includes a fifth switch element, a sixth switch element, a seventh switch element and an eighth switch element. One end of the first switch element and one end of the fifth switch element are connected to the first input end, the other end of the first switch element is connected to one end of the second switch element, the other end of the second switch element is connected to one end of the third switch element, the other end of the fifth switch element is connected to one end of the sixth switch element, the other end of the sixth switch element is connected to one end of the seventh switch element, and one end of the fourth switch element and one end of the eighth switch element are connected to the second input end. Further, controlling states of the switch elements of the other two bridge arms to make the three-phase neutral point clamped inverter output a single-phase signal includes: when a current of an inductor connected to the first single-phase bridge arm flows from the load to the inverter, controlling the first switch element and the eighth switch element to be in the non-conducting state, and controlling the fourth switch element and the fifth switch element to be in the conducting state.

Optionally, or in another embodiment, controlling two of the other switch elements in the first single-phase bridge arm and the second single-phase bridge arm to be in the conducting state to provide a freewheeling loop for an inductive current of the inverter includes: when an inductive current on the first single-phase bridge arm flows from the load to the inverter, controlling the first switch element, the eighth switch element, the fourth switch element and the fifth switch element to be in the non-conducting state, and controlling the second switch element and the seventh switch element to be in the conducting state.

Compared with the prior art, in the single-phase and three-level modulation method based on the three-phase NPC topology provided in the embodiment of the present disclosure, a third level, “zero level” is formed by using the Q2 switch tube and the Q3 switch tube in the bridge arm to become the freewheeling loop for the inductive current, which reduces the loss of the switch tubes and improves the operation efficiency of the inverter. Compared with the conventional full-bridge H4 modulation mode, the single-phase and three-level modulation method based on the three-phase NPC topology in accordance with the present disclosure has relatively small current ripples, smaller switch tube loss and smaller inductor loss. Thus, compared with the traditional full-bridge H4 modulation mode, the modulation method in accordance with the embodiment of the present disclosure will improve the operation efficiency of the inverter. In addition, the scheme according to the embodiment of the present disclosure does not need additional hardware devices and circuits, that is, only the three-level NPC topology of the conventional three-phase inverter is needed, which allows implementation of the integrated function of a single-phase and three-phase inverter efficiently without increasing the cost of hardware circuits, so that the conventional inverter has more possibilities for functional innovation.

Other features and advantages of the present disclosure will be set forth in the description which follows, and will be obvious in part from the description, or may be learned by practice of the present disclosure. The objects and other advantages of the present disclosure may be implemented and attained by structures particularly pointed out in the specification, the claims and the drawings.

### BRIEF DESCRIPTION OF THE DRAWINGS

The accompanying drawings are used for providing further understanding of the technical scheme of the present disclosure and forming a part of the specification, and are intended to explain the technical scheme of the present disclosure together with the embodiments of the present application and do not limit the technical scheme of the present disclosure.

FIG. 1(a) and FIG. 1(b) are schematic diagrams of the conventional three-phase inverter three-level NPC topology.

FIG. 2 is a schematic diagram of a single-phase modulation method (inductive current is positive) based on a three-phase NPC topology in accordance with an embodiment of the present disclosure.

FIG. 3 is a schematic diagram of a single-phase modulation method (inductive current is positive, freewheeling) based on a three-phase NPC topology in accordance with an embodiment of the present disclosure.

FIG. 4 is a schematic diagram of a single-phase modulation method (inductive current is negative) based on a three-phase NPC topology in accordance with an embodiment of the present disclosure.

FIG. 5 is a schematic diagram of a single-phase modulation method (inductive current is negative, freewheeling) based on a three-phase NPC topology in accordance with an embodiment of the present disclosure.

FIG. 6 is a schematic diagram of driving signals of various switch tubes of a single-phase three-level modulation method based on a three-phase NPC topology in accordance with an embodiment of the present disclosure.

FIG. 7 is a schematic diagram of voltage and current waveforms of a single-phase modulation method based on a three-phase NPC topology in accordance with an embodiment of the present disclosure.

FIG. 8 is a block diagram of a modulation apparatus based on a three-phase neutral point clamped inverter in accordance with an embodiment of the present disclosure.

### DETAILED DESCRIPTION

In order to make the objects, technical scheme and advantages of the present disclosure more clear, embodiments of the present disclosure will be described in detail hereinafter in conjunction with the accompanying drawings. It is should be noted that the embodiments in the present application and features of the embodiments may be combined with each other arbitrarily without conflict.

Acts shown in a flowchart of the accompanying drawings may be performed in a computer system such as a set of computer-executable instructions. Although a logical sequence is shown in the flowchart, in some cases the acts shown or described may be performed in an order different from that described herein.

An embodiment of the present disclosure provides a modulation method based on a three-phase neutral point clamped inverter, wherein the three-phase neutral point clamped inverter includes three bridge arms comprised of switch elements and three inductors, one end of the inductor is connected to an output end of the inverter, each of the bridge arms includes four switch elements and the switch elements of each of the bridge arms are connected in the same way, wherein in each of the bridge arms, a switch element is connected to a first input end of the three-phase neutral point clamped inverter and a switch element is connected to a second input end of the three-phase neutral point clamped inverter. The method includes: outputting a control signal for controlling all the switch elements of one of the three bridge arms to be in a non-conducting state, controlling states of the switch elements of the other two bridge arms to make the three-phase neutral point clamped inverter output a single-phase signal, wherein the two bridge arms are referred to as a first single-phase bridge arm and a second single-phase bridge arm respectively, when both switch elements connected to the first input end and switch elements connected to the second input end in the first single-phase bridge arm and the second single-phase bridge arm to be in the non-conducting state. The control signal further controls two of the other switch elements in the first single-phase bridge arm and the second single-phase bridge arm to be in a conducting state to provide a freewheeling loop for an inductive current of the inverter.

It should be noted that in one embodiment the control signal is a periodic control signal. The control signal includes driving signals of switch elements. The switch element may be a switch tube or other switching device or switching device circuit capable of achieving the same function.

Wherein the first single-phase bridge arm and the second single-phase bridge arm may be any two of the three bridge arms of the inverter.

In one embodiment of the present disclosure, the first single-phase bridge arm includes a first switch element, a second switch element, a third switch element and a fourth switch element, and the second single-phase bridge arm includes a fifth switch element, a sixth switch element, a seventh switch element and an eighth switch element, wherein one end of the first switch element and one end of the fifth switch element are connected to the first input end, the other end of the first switch element is connected to one end of the second switch element, the other end of the second switch element is connected to one end of the third switch element, the other end of the fifth switch element is connected to one end of the sixth switch element, the other end of the sixth switch element is connected to one end of the seventh switch element, and one end of the fourth switch element and one end of the eighth switch element are connected to the second input end. Further, controlling states of the switch elements of the other two bridge arms to make the three-phase neutral point clamped inverter output a single-phase signal includes: when a current of an inductor connected to the first single-phase bridge arm flows from the inverter to a load, controlling the first switch element and the eighth switch element to be in the conducting state, and controlling the fourth switch element and the fifth switch element to be in the non-conducting state.

In one embodiment of the present disclosure, controlling two of the other switch elements in the first single-phase bridge arm and the second single-phase bridge arm to be in the conducting state to provide a freewheeling loop for the inductive current of the inverter includes: when a current of an inductor connected to the first single-phase bridge arm flows from the inverter to the load, controlling the first switch element, the eighth switch element, the fourth switch element and the fifth switch element to be in the non-conducting state, and controlling the third switch element and the sixth switch element to be in the conducting state. At that point, the third switch element and the sixth switch element and two inductors constitute a current loop.

In one embodiment of the present disclosure, the first single-phase bridge arm includes a first switch element, a second switch element, a third switch element and a fourth switch element, and the second single-phase bridge arm includes a fifth switch element, a sixth switch element, a seventh switch element and an eighth switch element, wherein one end of the first switch element and one end of the fifth switch element are connected to the first input end, the other end of the first switch element is connected to one end of the second switch element, the other end of the second switch element is connected to one end of the third switch element, the other end of the fifth switch element is connected to one end of the sixth switch element, the other end of the sixth switch element is connected to one end of the seventh switch element, and one end of the fourth switch element and one end of the eighth switch element are connected to the second input end. Further, controlling states of the switch elements of the other two bridge arms to make the three-phase neutral point clamped inverter output a single-phase signal includes: when a current of inductor connected to the first single-phase bridge arm flows from the load to the inverter, controlling the first switch element and the eighth switch element to be in the non-conducting state, and controlling the fourth switch element and the fifth switch element to be in the conducting state.

In one embodiment of the present disclosure, controlling two of the other switch elements in the first single-phase bridge arm and the second single-phase bridge arm to be in the conducting state to provide a freewheeling loop for an inductive current of the inverter includes: when an inductive current on the first single-phase bridge arm as shown flows from the load end to the inverter, controlling the first switch element, the eighth switch element, the fourth switch element and the fifth switch element to be in the non-conducting state, and controlling the second switch element and the seventh switch element to be in the conducting state. At that point, the second switch element, the seventh switch element and two inductors constitute a current loop.

Compared with the prior art, in the single-phase and three-level modulation method based on the three-phase NPC topology provided in the embodiment of the present disclosure, a third level, “zero level”, is formed by using the Q2 switch tube and the Q3 switch tube in the bridge arm to become the freewheeling loop for the inductive current, which reduces the loss of the switch tubes and improves the operation efficiency of the inverter.

Compared with the conventional full-bridge H4 modulation mode, the single-phase and three-level modulation method based on the three-phase NPC topology in accordance with the present disclosure has relatively small current ripples, smaller switch tube loss and smaller inductor loss. Thus, compared with the conventional full-bridge H4 modulation method, the modulation method in accordance with the embodiment of the present disclosure will improve the operation efficiency of the inverter.

In addition, the modulation method according to the embodiment of the present disclosure does not need additional hardware devices and circuits, that is, only the three-level NPC topology of the conventional three-phase inverter is needed, which allows implementation of the integrated function of a single-phase and three-phase inverter efficiently without increasing the cost of hardware circuits, so that the conventional inverter has more possibilities for functional innovation.

The present disclosure will be further described through specific embodiments.

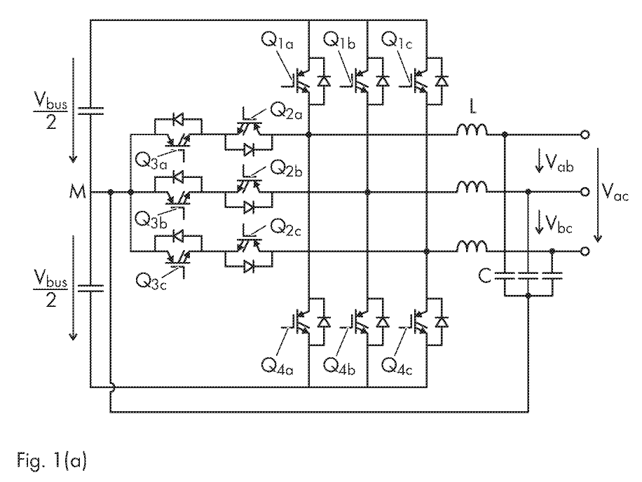

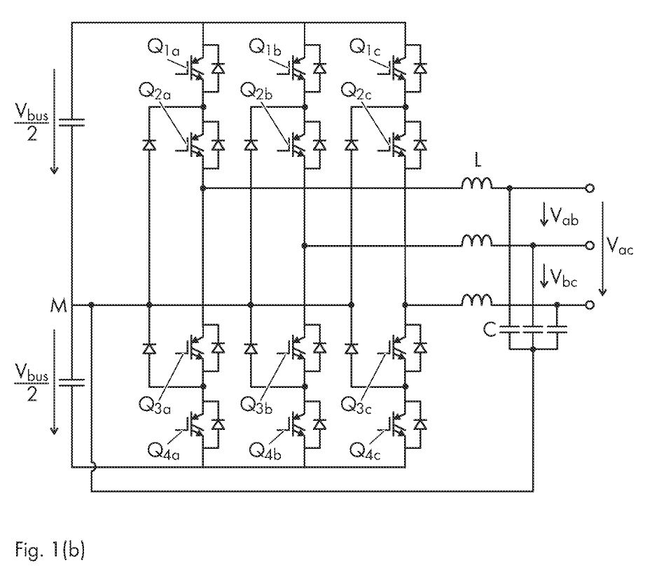

In the following embodiment, a three-phase NPC inverter shown in FIG. 1(a) is described by way of example. It should be noted that the scheme of the embodiment of the present disclosure is not limited to the inverter shown in FIG. 1(a), and other three-phase NPC inverters, such as the inverter shown in FIG. 1(b) and other similar inverters which are variants of those in FIG. 1(a) and FIG. 1(b), may also be used. In addition, in the following embodiments, single-phase power output by the A-phase and the B-phase is described by way of example. It should be noted that single-phase power output by the A-phase and C-phase or B-phase and C-phase can also be used, and implemented similarly by changing the switch tubes to corresponding switch tubes in the A-phase and C-phase, or B-phase and C-phase.

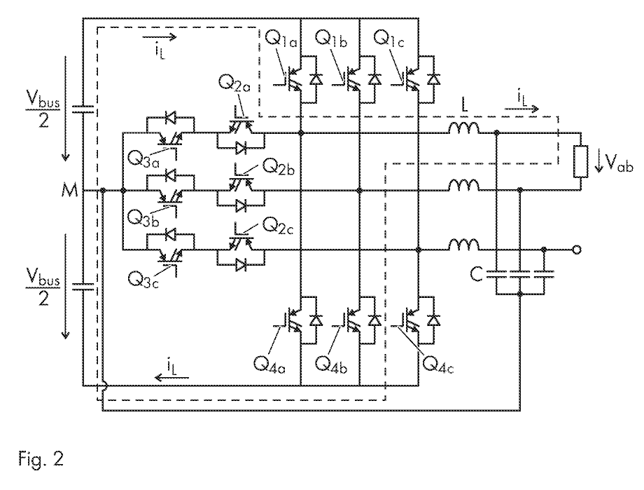

FIG. 2 is a schematic diagram of a single-phase modulation method (inductive current is positive) based on a three-phase NPC topology in accordance with an embodiment of the present disclosure. As shown in FIG. 2, a single-phase load is hung between outputs of A-phase and B-phase of the inverter, and the inverter needs to output single-phase power. When the inductive current or load current is positive (as shown in FIG. 2, at that point A-phase inductive current flows from the inverter to the load), a Q1a switch tube of an A-phase bridge arm and a Q4b switch tube of a B-phase bridge arm are controlled to be closed (conducting), and a Q4a switch tube of the A-phase bridge arm and a Q1b switch tube of the B-phase bridge arm are controlled to be opened, at this point, the states of Q2 and Q3 switch tubes of the A-phase bridge arm and the B-phase bridge arm can be closed or opened, and the output voltage and current are not affected. All switch tubes of a C-phase bridge arm are opened. A voltage difference on an inductor is positive Bus voltage in such operating mode.

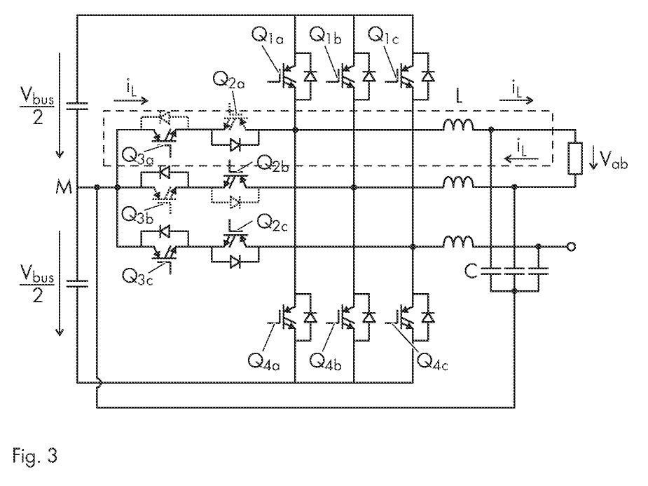

FIG. 3 is a schematic diagram of a single-phase modulation method (inductive current is positive, freewheeling) based on a three-phase NPC topology in accordance with an embodiment of the present disclosure. As shown in FIG. 3, when Q1a and Q4a switch tubes of an A-phase bridge arm and Q1b and Q4b switch tubes of a B-phase bridge arm are controlled to be opened, because there is energy on an inductor and inductive current cannot be changed suddenly, at this point, a Q3a switch tube of the A-phase bridge arm and a Q2b switch tube of the B-phase bridge arm are controlled to be closed, so as to provide a loop for the inductive current. The direction of the inductive current is positive (A-phase inductive current flows from the inverter to a load). A voltage difference in the inductor is zero voltage in such operating mode.

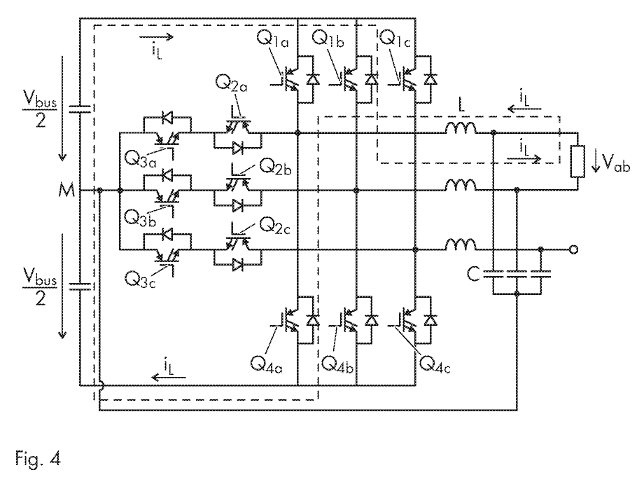

FIG. 4 is a schematic diagram of a single-phase modulation method (inductive current is negative) based on a three-phase NPC topology in accordance with an embodiment of the present disclosure. As shown in FIG. 4, when the inductive current or load current is negative (A-phase inductive current flows from a load to the inverter), a Q4a switch tube of an A-phase bridge arm and a Q1b switch tube of a B-phase bridge arm are controlled to be closed, and a Q1a switch tube of the A-phase bridge arm and a Q4b switch tube of the B-phase bridge arm are controlled to be opened. The states of Q2 and Q3 switch tubes of the A-phase bridge arm and the B-phase bridge arm can be closed or opened, and output voltage and current are not affected. A voltage difference on an inductor is negative Bus voltage in such operating mode.

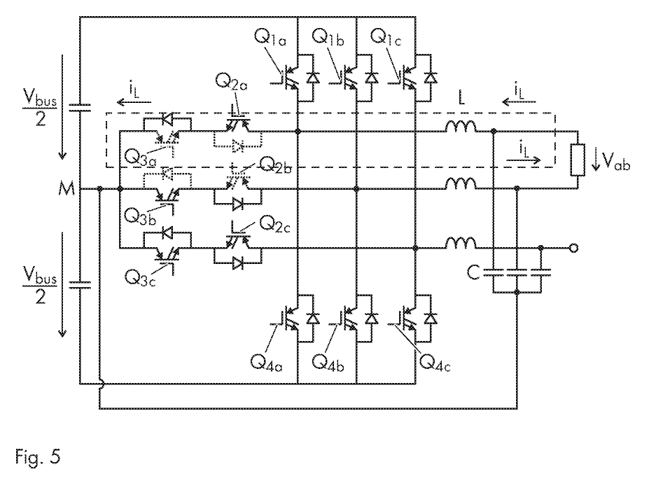

FIG. 5 is a schematic diagram of a single-phase modulation method (inductive current is negative, freewheeling) based on a three-phase NPC topology in accordance with an embodiment of the present disclosure. As shown in FIG. 5, when Q1a and Q4a switch tubes of an A-phase bridge arm and Q1b and Q4b switch tubes of a B-phase bridge arm are opened, because there is energy on an inductor and the inductive current cannot be changed suddenly, a Q2a switch tube of the A-phase bridge arm and a Q3b switch tube of the B-phase bridge arm need to be controlled to be closed, so as to provide a loop for the inductive current. The direction of the inductive current is negative (A-phase inductive current flows from the load to the inverter). A voltage difference in the inductor is zero voltage in such operating mode.

The scheme in accordance with the embodiment of the disclosure can implement the single-phase modulation mode without modifying the hardware circuit, and can reduce the switch tube loss through the three-level modulation mode and improve the operation efficiency of the inverter in the single-phase mode.

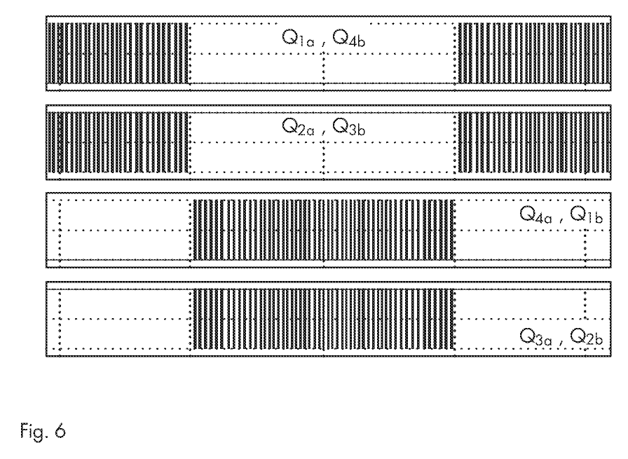

FIG. 6 is a schematic diagram of driving signals of various switch tubes of a single-phase three-level modulation method based on a three-phase NPC topology in accordance with an embodiment of the present disclosure. All switch tubes of a C-phase bridge arm are in an open mode, not shown in FIG. 6. As shown in FIG. 6, the drive signals of a Q1a switch tube of an A-phase bridge arm and a Q4b switch tube of a B-phase bridge arm are the same; the drive signals of a Q2a switch tube of the A-phase bridge arm and a Q3b switch tube of the B-phase bridge arm are the same; the drive signals of a Q3a switch tube of the A-phase bridge arm and a Q2b switch tube of a B-phase bridge arm are the same; and the drive signals of a Q4a switch tube of the A-phase bridge arm and a Q1b switch tube of the B-phase bridge arm are the same.

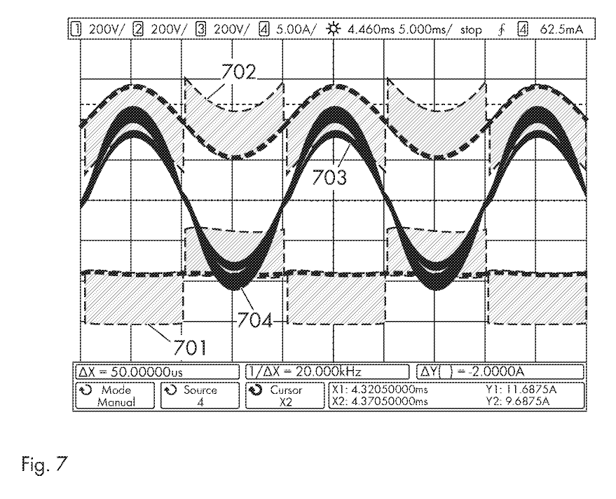

FIG. 7 is a schematic diagram of voltage and current waveforms of a single-phase modulation method based on a three-phase NPC topology in accordance with an embodiment of the present disclosure. As shown in FIG. 7, a first channel 701 is output voltage for PV− of output phase voltage of the inverter; the second channel 702 is a voltage difference across an output inductor; the third channel 703 is the output voltage of the inverter; and the fourth Channel 704 is a load current, the load is R load. It can be seen from FIG. 7 that the output voltage and inductive voltage in the modulation method according to the embodiment of the present disclosure show three levels obviously.

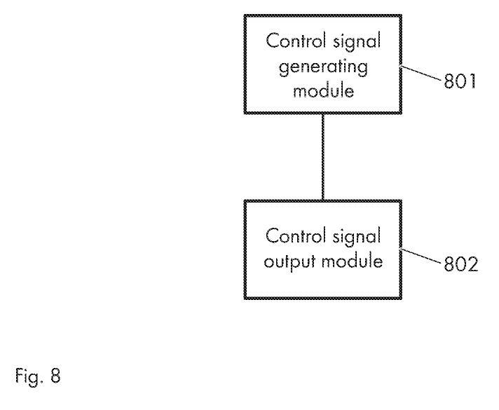

As shown in FIG. 8, an embodiment of the present disclosure further provides a modulation apparatus based on a three-phase neutral point clamped inverter, and the three-phase neutral point clamped inverter includes three bridge arms comprised of switch elements and three inductors, wherein one end of the inductor is connected to an output end of the inverter, each of the bridge arms includes four switch elements and the switch elements of each of the bridge arms are connected in the same way, wherein in each of the bridge arms, a switch element is connected to a first input end of the three-phase neutral point clamped inverter and a switch element is connected to a second input end of the three-phase neutral point clamped inverter. The modulation apparatus includes: a control signal generating module 801 configured to generate a control signal; and a control signal output module 802 configured to output the control signal to the switch elements of the inverter, control all the switch elements of one of the three bridge arms to be in a non-conducting state, and control states of the switch elements of the other two bridge arms to make the three-phase neutral point clamped inverter output a single-phase signal. The two bridge arms are referred to as a first single-phase bridge arm and a second single-phase bridge arm. Further, when controlling both the switch elements connected to the first input end and the switch elements connected to the second input end in the first single-phase bridge arm and the second single-phase bridge arm to be in the non-conducting state, the control signal generating module, via the output module, is configured to control two of the other switch elements in the first single-phase bridge arm and the second single-phase bridge arm to be in a conducting state to provide a freewheeling loop for an inductive current of the inverter.

In one embodiment of the present disclosure, the first single-phase bridge arm includes a first switch element, a second switch element, a third switch element and a fourth switch element, and the second single-phase bridge arm includes a fifth switch element, a sixth switch element, a seventh switch element and an eighth switch element. One end of the first switch element and one end of the fifth switch element are connected to the first input end, the other end of the first switch element is connected to one end of the second switch element, the other end of the second switch element is connected to one end of the third switch element, the other end of the fifth switch element is connected to one end of the sixth switch element, the other end of the sixth switch element is connected to one end of the seventh switch element, and one end of the fourth switch element and one end of the eighth switch element are connected to the second input end. Further, controlling states of the switch elements of the other two bridge arms to make the three-phase neutral point clamped inverter output the a single-phase signal includes: when a current of an inductor connected to the first single-phase bridge arm flows from the inverter to a load, controlling the first switch element and the eighth switch element to be in the conducting state, and controlling the fourth switch element and the fifth switch element to be in the non-conducting state.

In one embodiment of the present disclosure, controlling two of the other switch elements in the first single-phase bridge arm and the second single-phase bridge arm to be in the conducting state to provide a freewheeling loop for an inductive current of the inverter includes: when a current of an inductor connected to the first single-phase bridge arm flows from the inverter to a load, controlling the first switch element, the eighth switch element, the fourth switch element and the fifth switch element to be in the non-conducting state, and controlling the third switch element and the sixth switch element to be in the conducting state.

In one embodiment of the present disclosure, the first single-phase bridge arm includes a first switch element, a second switch element, a third switch element and a fourth switch element, and the second single-phase bridge arm includes a fifth switch element, a sixth switch element, a seventh switch element and an eighth switch element. One end of the first switch element and one end of the fifth switch element are connected to the first input end, the other end of the first switch element is connected to one end of the second switch element, the other end of the second switch element is connected to one end of the third switch element, the other end of the fifth switch element is connected to one end of the sixth switch element, the other end of the sixth switch element is connected to one end of the seventh switch element, and one end of the fourth switch element and one end of the eighth switch element are connected to the second input end. Further, controlling states of the switch elements of the other two bridge arms to make the three-phase neutral point clamped inverter output a single-phase signal includes: when a current inductor connected to the first single-phase bridge arm flows from the load to the inverter, controlling the first switch element and the eighth switch element to be in the non-conducting state, and controlling the fourth switch element and the fifth switch element to be in the conducting state.

In one embodiment of the present disclosure, controlling two of the other switch elements in the first single-phase bridge arm and the second single-phase bridge arm to be in the conducting state to provide a freewheeling loop for an inductive current of the inverter includes: when the inductive current on the first single-phase bridge arm flows from the load to the inverter, controlling the first switch element, the eighth switch element, the fourth switch element and the fifth switch element to be in the non-conducting state, and controlling the second switch element and the seventh switch element to be in the conducting state.

An embodiment of the present disclosure further provides an inverter including the above-described modulation apparatus.

While the embodiments disclosed by the present disclosure are described as above, contents described are merely embodiments adopted in order to understand the present disclosure easily and are not intended to limit the present disclosure. Any modification and variation can be made in the implemented form and detail by those skilled in the art to which the present disclosure pertains without departing from the spirit and scope of the present disclosure. However, the scope of patent protection of the present disclosure is still subject to the scope defined by the appended claims.

1. A modulation method based on a three-phase neutral point clamped inverter, wherein the three-phase neutral point clamped inverter comprises three bridge arms comprised of switch elements and three inductors, one end of the inductor is connected to an output end of the inverter, each of the bridge arms comprises four switch elements and the switch elements of each of the bridge arms are connected in a same way, wherein in each of the bridge arms, a switch element is connected to a first input end of the three-phase neutral point clamped inverter and a switch element is connected to a second input end of the three-phase neutral point clamped inverter, the method comprises:
outputting a control signal for controlling all switch elements of one of the three bridge arms to be in a non-conducting state,
controlling states of switch elements of the other two bridge arms to make the three-phase neutral point clamped inverter output a single-phase signal,
wherein the other two bridge arms are referred to as a first single-phase bridge arm and a second single-phase bridge arm,
when controlling both switch elements connected to the first input end and switch elements connected to the second input end in the first single-phase bridge arm and the second single-phase bridge arm to be in the non-conducting state, controlling two of the other switch elements in the first single-phase bridge arm and the second single-phase bridge arm to be in a conducting state to provide a freewheeling loop for an inductive current of the inverter.

2. The method according to claim 1,
wherein the first single-phase bridge arm comprises a first switch element, a second switch element, a third switch element and a fourth switch element, and wherein the second single-phase bridge arm comprises a fifth switch element, a sixth switch element, a seventh switch element and an eighth switch element,
wherein one end of the first switch element and one end of the fifth switch element are connected to the first input end,
wherein the other end of the first switch element is connected to one end of the second switch element,
wherein the other end of the second switch element is connected to one end of the third switch element,
wherein the other end of the fifth switch element is connected to one end of the sixth switch element,
wherein the other end of the sixth switch element is connected to one end of the seventh switch element, and one end of the fourth switch element and one end of the eighth switch element are connected to the second input end; and
wherein said controlling states of the switch elements of the other two bridge arms to make the three-phase neutral point clamped inverter output the single-phase signals comprises:
when a current of an inductor connected to the first single-phase bridge arm flows from the inverter to a load, controlling the first switch element and the eighth switch element to be in the conducting state, and controlling the fourth switch element and the fifth switch element to be in the non-conducting state.

3. The method according to claim 2, wherein said controlling two of the other switch elements in the first single-phase bridge arm and the second single-phase bridge arm to be in the conducting state to provide a freewheeling loop for an inductive current of the inverter comprises:
when a current of an inductor connected to the first single-phase bridge arm flows from the inverter to the load,
controlling the first switch element, the eighth switch element, the fourth switch element and the fifth switch element to be in the non-conducting state, and
controlling the third switch element and the sixth switch element to be in the conducting state.

4. The method according to claim 1,
wherein the first single-phase bridge arm comprises a first switch element, a second switch element, a third switch element and a fourth switch element, and the second single-phase bridge arm comprises a fifth switch element, a sixth switch element, a seventh switch element and an eighth switch element,
wherein one end of the first switch element and one end of the fifth switch element are connected to the first input end,
wherein the other end of the first switch element is connected to one end of the second switch element,
wherein the other end of the second switch element is connected to one end of the third switch element,
wherein the other end of the fifth switch element is connected to one end of the sixth switch element,
wherein the other end of the sixth switch element is connected to one end of the seventh switch element, and one end of the fourth switch element and one end of the eighth switch element are connected to the second input end; and
wherein said controlling states of the switch elements of the other two bridge arms to make the three-phase neutral point clamped inverter output a single-phase signal comprises:
when a current of an inductor connected to the first single-phase bridge arm flows from the load to the inverter, controlling the first switch element and the eighth switch element to be in the non-conducting state, and controlling the fourth switch element and the fifth switch element to be in the conducting state.

5. The method according to claim 4, wherein said controlling two of the other switch elements in the first single-phase bridge arm and the second single-phase bridge arm to be in the conducting state to provide a freewheeling loop for an inductive current of the inverter comprises:
when an inductive current on the first single-phase bridge arm flows from the load to the inverter, controlling the first switch element, the eighth switch element, the fourth switch element and the fifth switch element to be in the non-conducting state, and controlling the second switch element and the seventh switch element to be in the conducting state.

6. A modulation apparatus based on a three-phase neutral point clamped inverter, wherein the three-phase neutral point clamped inverter comprises three bridge arms comprised of switch elements and three inductors, one end of the inductor is connected to an output end of the inverter, wherein each of the bridge arms comprises four switch elements and the switch elements of each of the bridge arms are connected in a same way, wherein in each of the bridge arms, a switch element is connected to a first input end of the three-phase neutral point clamped inverter and a switch element is connected to a second input end of the three-phase neutral point clamped inverter, the modulation apparatus comprising:
a control signal generating module configured to generate a control signal; and
a control signal output module configured to:
output the control signal to the switch elements of the inverter,
control all switch elements of one of the three bridge arms to be in a non-conducting state,
control states of the switch elements of the other two bridge arms to make the three-phase neutral point clamped inverter output a single-phase signal,
wherein the two bridge arms are referred to as a first single-phase bridge arm and a second single-phase bridge arm,
when controlling both switch elements connected to the first input end and switch elements connected to the second input end in the first single-phase bridge arm and the second single-phase bridge arm to be in the non-conducting state, control two of the other switch elements in the first single-phase bridge arm and the second single-phase bridge arm to be in a conducting state to provide a freewheeling loop for an inductive current of the inverter.

7. The modulation apparatus according to claim 6,
wherein the first single-phase bridge arm comprises a first switch element, a second switch element, a third switch element and a fourth switch element, and the second single-phase bridge arm comprises a fifth switch element, a sixth switch element, a seventh switch element and an eighth switch element,
wherein one end of the first switch element and one end of the fifth switch element are connected to the first input end,
wherein the other end of the first switch element is connected to one end of the second switch element,
wherein the other end of the second switch element is connected to one end of the third switch element,
wherein the other end of the fifth switch element is connected to one end of the sixth switch element,
wherein the other end of the sixth switch element is connected to one end of the seventh switch element, and one end of the fourth switch element and one end of the eighth switch element are connected to the second input end; and
wherein said controlling states of the switch elements of the other two bridge arms to make the three-phase neutral point clamped inverter output a single-phase signal comprises:
when a current of an inductor connected to the first single-phase bridge arm flows from the inverter to a load, controlling the first switch element and the eighth switch element to be in the conducting state, and controlling the fourth switch element and the fifth switch element to be in the non-conducting state.

8. The modulation apparatus according to claim 7, wherein said controlling two of the other switch elements in the first single-phase bridge arm and the second single-phase bridge arm to be in the conducting state to provide a freewheeling loop for an inductive current of the inverter comprises:
when a current of an inductor connected to the first single-phase bridge arm flows from the inverter to the load, controlling the first switch element, the eighth switch element, the fourth switch element and the fifth switch element to be in the non-conducting state, and controlling the third switch element and the sixth switch element to be in the conducting state.

9. The modulation apparatus according to claim 6,
wherein the first single-phase bridge arm comprises a first switch element, a second switch element, a third switch element and a fourth switch element,
wherein the second single-phase bridge arm comprises a fifth switch element, a sixth switch element, a seventh switch element and an eighth switch element,
wherein one end of the first switch element and one end of the fifth switch element are connected to the first input end,
wherein the other end of the first switch element is connected to one end of the second switch element,
wherein the other end of the second switch element is connected to one end of the third switch element,
wherein the other end of the fifth switch element is connected to one end of the sixth switch element,
wherein the other end of the sixth switch element is connected to one end of the seventh switch element, and one end of the fourth switch element and one end of the eighth switch element are connected to the second input end; and
wherein said controlling states of the switch elements of the other two bridge arms to make the three-phase neutral point clamped inverter output a single-phase signal comprises:
when a current of an inductor connected to the first single-phase bridge arm flows from the load to the inverter, controlling the first switch element and the eighth switch element to be in the non-conducting state, and controlling the fourth switch element and the fifth switch element to be in the conducting state.

10. The modulation apparatus according to claim 9, wherein said controlling two of the other switch elements in the first single-phase bridge arm and the second single-phase bridge arm to be in the conducting state to provide a freewheeling loop for an inductive current of the inverter comprises:
when an inductive current on the first single-phase bridge arm as shown flows from the load to the inverter, controlling the first switch element, the eighth switch element, the fourth switch element and the fifth switch element to be in the non-conducting state, and controlling the second switch element and the seventh switch element to be in the conducting state.
